(19) United States
(12) Patent Application Publication
(10) Pub. No.: US 2018/0146705 A1
(43) Pub. Date: May 31, 2018

(54) METHOD FOR THE TREATMENT OF CORN KERNELS INTENDED FOR THE PRODUCTION OF POPCORN USING MICROWAVE APPLIANCES, AND RESULTING PRODUCT

(71) Applicant: DODE, S.A., Valldoreix (ES)

(72) Inventor: Carlos Galceran Martorell, Valldoreix (ES)

(21) Appl. No.: 15/572,193

(22) PCT Filed: May 4, 2016
(86) PCT No.: PCT/ES2016/070340

§ 371 Date: Nov. 7, 2017

(30) Foreign Application Priority Data
May 7, 2015 (ES) P201530621

(51) Int. Cl. A23P 20/10; A23L 7/183

(52) U.S. Cl. CPC A23P 20/10; A23V 2002/00; A23L 7/183

(57) ABSTRACT

In the method of the main patent, corn kernels coated with sunflower lecithin and additives are obtained. According to the improvements, the additives and sunflower lecithin can be added in liquid state, solid state or both, and can be mixed and subsequently filtered before reaching a final mixer (2) to which are added not only the additives and sunflower lecithin, in any state, but also the corn kernels (1), in order to coat the corn kernels inside the mixer. The improvements also provide for the substitution of sunflower lecithin by other compounds with which similar results can be obtained, such as fructose syrup, liquid glucose, corn syrup, molasses, inverted sugar syrup or cornstarch, the kernels obtained being able to be coated with more than one coating of a different nature.

### OBJECT OF THE INVENTION

The present invention relates to improvements to the invention patent P201231330, in which a method is described for the treatment of corn kernels intended for the production of popcorn using microwave appliances, wherein the corn kernel or kernels are coated with a solution of a main product, specifically sunflower lecithin, and a flavoring product as an additive.

The object of the invention is to obtain an improved final product (corn kernels coated with an additive and lecithin by carrying out specific steps of the process and incorporating lecithin and the additives or flavors in different ways.

Another object of the invention is also to provide other ingredients that obtain the same effects as sunflower lecithin, such as fructose syrup, liquid glucose, corn syrup, molasses, inverted sugar syrup, cornstarch and/or any other food product with similar characteristics.

### BACKGROUND OF THE INVENTION

In the method described in the main invention patent P201231330, the treatment of the corn kernels intended for the production of popcorn using microwave appliances, the corn is impregnated for a pre-defined time in a solution of a main product, specifically sunflower lecithin, and a flavoring product or additive, which may be sugar, butter, salt, etc.

In other words, in said method, the product produced is healthier than conventional products since it is low-fat and does not contain allergens, thus producing a final crunchy product without clumping, and therefore ensuring that the popcorn ultimately produced are as homogeneous as possible, substituting classic oils used in conventional methods to coat the corn kernel with sunflower lecithin, a product that is much healthier and makes it possible to obtain improved results as commented above.

However, in said method, there is no reference to the form of incorporation and state of the lecithin and additives or flavors, such that it also does not allude to the way of treating said components before impregnating the corn for the coating thereof.

Likewise, it was experimentally verified that sunflower lecithin can be substituted by other ingredients that achieve the same results.

### DESCRIPTION OF THE INVENTION

The improvements that are mentioned are firstly based on the fact that the sunflower lecithin and the additives or flavors are added together with the corn kernels into a common mixer, in which the outer impregnation of the corn kernels with this lecithin and the additives mixed with them takes place.

Said final mixer used in the coating process can have different types of elements for the operation thereof, such as blades, helices, bands, etc., and it can be heated depending on the products that require it.

Furthermore, and according to other improvements of the invention, the lecithin and additives are included in the coating solution in liquid state.

According to another improvement, the lecithin and additives are included in the coating solution in solid state.

In another improvement, the lecithin and additives are included in the solution where one is in liquid state and the other is in solid state, indistinctly.

In any case, the liquid additives with the liquid lecithin pass onto a liquid mixer for stirring both components in order to subsequently filter them; in other words, the mixture is passed through sieves that filter the result, preventing lumps or unwanted material from passing through, so that these liquid additives and liquid lecithin as a mixture pass onto the final mixture referred to above.

Furthermore, the liquid lecithin with the liquid additives, as well as the solid lecithin and solid additives can pass onto a mixer together, and from this mixer, the mixture passes onto a kneader, in which a final product is produced that is mixed and sifted, with or without pressure, based on the characteristics of the components, once again passing this kneaded mixture onto the final mixer referred to initially.

In addition, the solid lecithin with the solid additives passes onto a mixer of solids, prior to the pre-mixing process, such that said mixture passes through a sieve to separate the lumps and regulate the size of the particles before reaching the final mixer.

In either case, the corn kernels with lecithin and additives, whether they are liquids, solids, combined or not, are treated in the final mixer to obtain the coating of the corn kernels, thus finally carrying out a weighing and packaging process of the product.

It is worth noting that the additives may be, as mentioned above, any type of flavor, whether they are salts, sweeteners, acidulants, spicy flavors, bitter flavors, fixatives such as food lacquers, food glues, as well as other products such as dyes, binders, thickeners, etc.

Lastly, it should be noted that the coating of the corn kernels can be carried out in a number of successive phases, in other words, producing a coating based on several layers, without it affecting the essence of the invention.

A loose kernel is thus produced without lumps, which opens well when popped in the microwave, and all this without added fats and being able to be stored at room temperatures higher than traditional temperatures without altering the organoleptic qualities thereof.

As mentioned above, the sunflower lecithin can be substituted by fructose syrup, liquid glucose, corn syrup, molasses, inverted sugar syrup, cornstarch and/or any other food product with similar characteristics.

Lastly, it is worth mentioning that the method of the invention can be repeated as many times as necessary, in order to produce a product with several layers.

### DESCRIPTION OF THE DRAWINGS

As a complement to the description provided below, and for the purpose of helping to make the characteristics of the invention more readily understandable, in accordance with a preferred practical embodiment thereof, said description is accompanied by a FIGURE, which by way of illustration and not limitation represents the following:

FIG. 1 shows a representation corresponding to a block diagram of the different possibilities that can be carried out in the method object of the improvements of the invention.

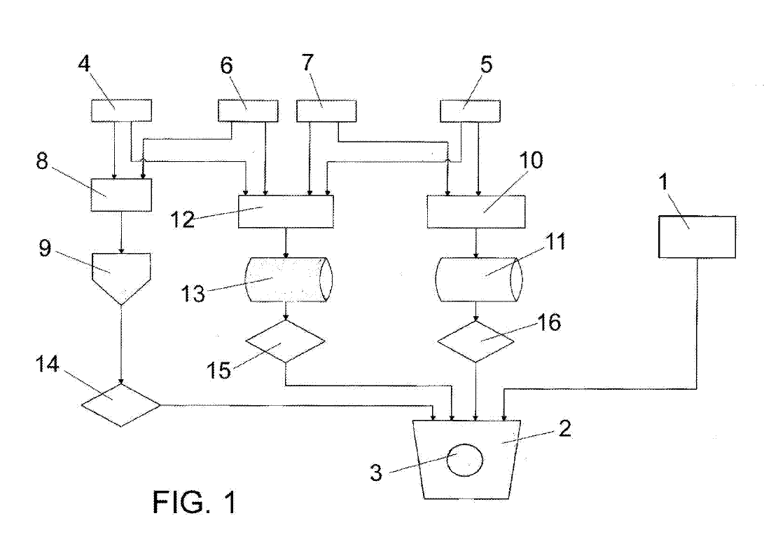

### PREFERRED EMBODIMENT OF THE INVENTION

As can be seen in the FIGURE discussed above, the corn kernels (1) are added to a common and final mixer (2) in order to produce a product (3) coated in sunflower lecithin and additives, which are also added to said mixer (2).

These additives can be liquid additives (4) and/or solid additives (5), while the lecithin can be liquid lecithin (6) and/or solid lecithin (7).

In any case, the liquid additives (4) and the liquid lecithin (6) pass through a pre-stirrer (8) and from this pre-stirrer, they pass onto a mixer of liquids (9); while in the case of solid lecithin (7) and solid additives (5), they pass onto a pre-mixer (10) and from this pre-mixer, onto a mixer of solids (11).

Furthermore, the liquid lecithin (6) and the solid lecithin (7), together with the liquid additives (4) and solid additives (5) are passed through a mixer (12) and from this mixer to a kneader (13).

The resulting mixture in the mixer of liquids (9) is passed through a filter (14) to prevent lumps or unwanted material from passing through, the product produced in the kneader (13) also being passed through a filter (15); while the mixture of solids (11) also passes through a sieve (16) to prevent lumps and regulate the size of the particle, such the product passing through the filter (14) as well as the product passing through the filter (15) and the product passing through the sieve (16) are added to the common mixture (2) together with the corn kernels (1) to be treated, in order to produce the corresponding coating, whether it is from one or more than one layers of coating, based on the specific needs of each case, after which said kernels are weighed and packaged.

The method is also applicable by substituting the sunflower lecithin with fructose syrup, liquid glucose, corn syrup, molasses, inverted sugar syrup, cornstarch and/or any other food product with similar characteristics.

1. Method for the treatment of corn kernels intended for the production of popcorn using microwave appliances, and resulting product, wherein the corn kernels (1) are coated with a compound and one or more additives, characterized in that said compound is made from sunflower lecithin, fructose syrup, liquid glucose, corn syrup, molasses, inverted sugar syrup or cornstarch, such that said compound and additives are added, together with the corn kernels, into a common mixer (2) in which the outer impregnation of the corn kernels takes place.

2. Method according to claim 1, characterized in that the compound and the one or more additives are included in the coating solution in liquid state.

3. Method according to claim 1, characterized in that the compound and the one or more additives are included in the coating solution in solid state.

4. Method according to claim 1, characterized in that in the coating solution, the compound is included in liquid state, while the one or more additives are included in solid state.

5. Method according to claim 1, characterized in that in the coating solution, the compound is included in solid state, while the one or more additives are included in liquid state.

6. Method according to claim 1, characterized in that the compound and the one or more additives, both in liquid state, are incorporated into a mixer of liquids (9) after passing through a pre-stirrer (8) in order to produce a mixture that is subsequently filtered in a filter (14) before passing onto the final mixer (2).

7. Method according to claim 1, characterized in that the compound and the one or more additives, both in solid state, are subjected to pre-mixing and afterwards, are passed onto a mixer of solids (11) in order to obtain a mixture that is sifted (16) before being added to the final mixer (2).

8. Method according to claim 1, characterized in that the compound in liquid state, the compound in solid state, the one or more additives in liquid state and the one or more additives in solid state are passed together onto a mixer (12) and from this mixer onto a kneader (13) in order to obtain a product that is subject to filtering (15) before passing onto the final mixer (2).

9. Method according to claim 1, characterized in that the one or more additives may be formed by flavorings including salts, sweeteners, acidulants, spicy flavors, bitter flavors, as well as fixatives including food lacquers, food glues, or even dyes, binders, thickeners, and similar.

10. Method according to claim 1, characterized in that the process can be repeated as many times as different coating or layers are necessary for each corn kernel.
